(19) United States
(12) Patent Application Publication
(10) Pub. No.: US 2020/0039033 A1
(43) Pub. Date: Feb. 6, 2020

(54) QUICK CLAMPING POSITIONING DEVICE

(71) Applicant: Shenter Enterprise Co., Ltd., Chang-Hua Hsien (TW)

(72) Inventors: Ming-Hsiao LAI, Chang-Hua Hsien (TW); Kuo-Shu HUANG, Changhua City (TW)

(21) Appl. No.: 16/055,717

(22) Filed: Aug. 6, 2018

(51) Int. Cl. B25B 11/02; B25B 5/16

(52) U.S. Cl. CPC B25B 11/02; B25B 33/005; B25B 5/16

(57) ABSTRACT

A quick clamping positioning device has a main body, a fixture block protruding therefrom and chucked in a chucking slot. The main body has a shoulder on both sides of the fixture block, a manipulation piece, a fastening piece fixed to the manipulation piece and corresponding to the top surface of the fixture block. The fastening piece has a major and a minor axis, wherein the major axis is shorter than the length of a chucking slot, and the minor axis is shorter than the width of the chucking slot, wherein the chucking slot is formed in an object. The fastening piece penetrates through the chucking slot and is held in a holding space. The fastening piece is driven by the manipulation piece to rotate at a specific rotation angle against the main body, and to clamp the parts on both sides of the chucking slot with the two shoulders.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates generally to a positioning device, and more particularly to an innovative structure design for quick clamping positioning and convenient disassembly.

### 2. Description of Related Art Including Information Disclosed Under 37 CFR 1.97 and 37 CFR 1.98

The most convenient way to combine two different components is to use bolts and nuts. There are many pneumatic or electric tools on the market for fastening or loosening bolts and nuts quickly. However, the operators sometimes have no choice but to use general hand tools, thus when the bolt and nut are tightened up mutually and gradually, the user must use another tool to prevent the nut from turning together with the bolt, so as to make sure the bolt and nut are fastened, the operation is not convenient at all. In addition, to disassemble two components fastened by bolts and nuts, the nuts and bolts must be disengaged completely, the operating time is apparently not so economical.

### BRIEF SUMMARY OF THE INVENTION

The primary objective of the present invention is to provide a quick clamping positioning device to solve said problem.

To attain said purpose, the present invention is fixed to an object with a holding space; a chucking slot connected to the holding space is formed in the surface of the object, and both sides of the chucking slot are provided with an alar part respectively, wherein the chucking slot is a strip structure. The quick clamping positioning device comprises a main body, a fixture block protruding from the main body to be chucked in the chucking slot. The main body is provided with a shoulder on both sides of the fixture block. A manipulation piece rotatably penetrating through the main body and the fixture block in turn. A fastening piece fixed to the manipulation piece and corresponding to the top surface of the fixture block. The fastening piece is an approximately long structure with a major axis and a minor axis, wherein the length of major axis of the fastening piece is smaller than the length of the chucking slot, and the length of minor axis of the fastening piece is smaller than the width of the chucking slot. The fastening piece is to penetrate through the chucking slot and held in the holding space. The fastening piece is driven by the manipulation piece to optionally rotate at a specific rotation angle against the main body, and to optionally clamp the two alar parts of the object with the two shoulders.

### BRIEF DESCRIPTION OF THE SEVERAL VIEWS OF THE DRAWINGS

FIG. 1 is a three-dimensional exploded diagram of the first implementation pattern of the present invention.

FIG. 2 is a three-dimensional exploded diagram of the second implementation pattern of the present invention.

FIG. 3 is a three-dimensional outside view of the manipulation piece of the present invention.

FIG. 4 is a three-dimensional outside view of main body and fastening piece of the present invention.

FIG. 5 is a first operation chart of the first implementation pattern of the present invention.

FIG. 6 is a second operation chart of the first implementation pattern of the present invention.

FIG. 7 is a first operation chart of the second implementation pattern of the present invention.

FIG. 8 is a second operation chart of the second implementation pattern of the present invention.

FIG. 9 is a schematic diagram of another clamping mode of fastening piece in the second implementation pattern of the present invention.

FIG. 10 is a three-dimensional outside view of the second implementation pattern of manipulation piece of the present invention.

FIG. 11 is a reference diagram for the usage mode of the second implementation pattern of manipulation piece of the present invention.

FIG. 12 is a three-dimensional outside view of the second embodiment of main body of the present invention.

FIG. 13 is a three-dimensional outside view of the third embodiment of main body of the present invention.

FIG. 14 is a three-dimensional outside view of the fourth embodiment of main body of the present invention.

### DETAILED DESCRIPTION OF THE INVENTION

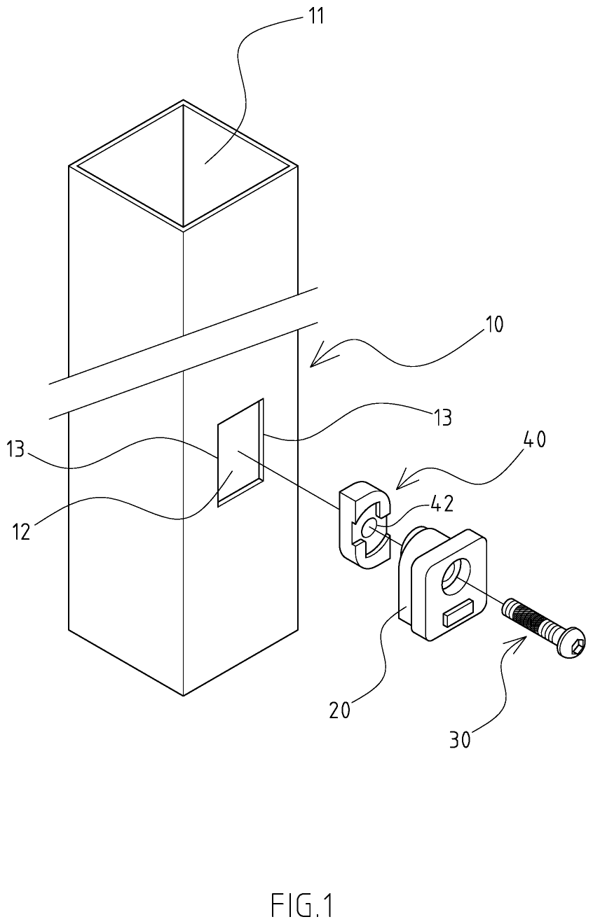

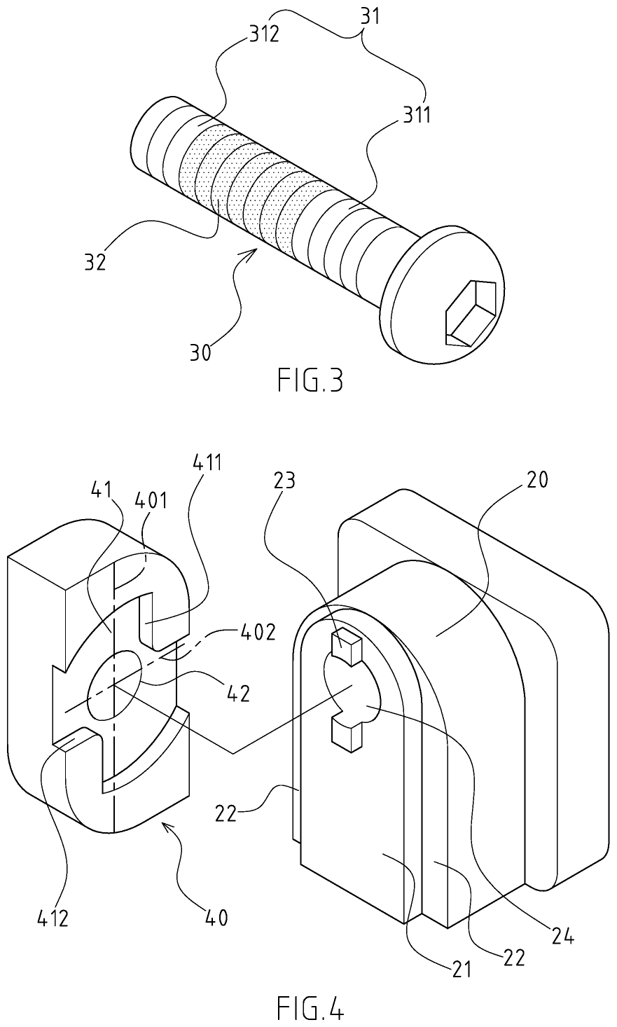

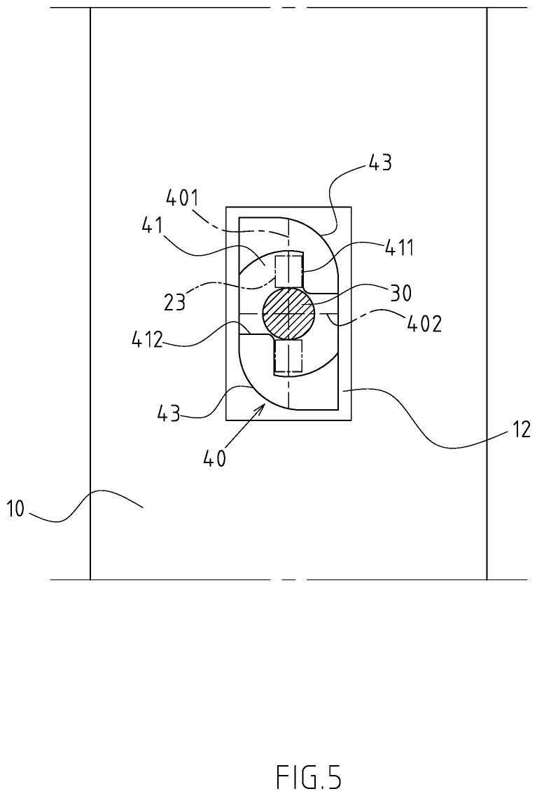

FIGS. 1, 3, 4 and 5 show the preferred embodiments of the quick clamping positioning device of the present invention, but the embodiments are for illustration only, the patent application is not limited to this structure. Said quick clamping positioning device is fixed to an object 10 with a holding space 11. In this preferred embodiment, the object 10 is a polygonal tube; a chucking slot 12 connected to the holding space 11 is formed in the surface of the object 10, and both sides of the chucking slot 12 are provided with an alar part 13 respectively, wherein the chucking slot 12 is a strip structure. The quick clamping positioning device comprises a main body 20, a fixture block 21 protruding from the main body 20 to be chucked in the chucking slot 12, the main body 20 is provided with a shoulder 22 on both sides of the fixture block 21. A manipulation piece 30 rotatably penetrates through the main body 20 and the fixture block 21 in turn. A fastening piece 40 is fixed to the manipulation piece 30 and corresponding to the top surface of the fixture block 21. The fastening piece 40 is an approximately long structure with a major axis 401 and a minor axis 402, wherein the length of major axis 401 of the fastening piece 40 is smaller than the length of the chucking slot 12, and the length of minor axis 402 of the fastening piece 40 is smaller than the width of the chucking slot 12. The fastening piece 40 is to penetrate through the chucking slot 12 and held in the holding space 11. The fastening piece 40 is driven by the manipulation piece 30 to optionally rotate at a specific rotation angle against the main body 20, and to optionally clamp the two alar parts 13 of the object 10 with the two shoulders 22.

An arc chute 41 is formed in one face of the fastening piece 40 corresponding to the fixture block 21, one end of the arc chute 41 corresponding to the major axis 401 is defined as a first stop face 411, and one end of the arc chute 41 corresponding to the minor axis 402 is defined as a second stop face 412. A stopper 23 held in the arc chute 41 protrudes from the top surface of the fixture block 21. When the stopper 23 props the first stop face 411, and the orthographic projection of the fastening piece 40 is covered by the chucking slot 12, the fastening piece 40 can be disengaged from/placed in the holding space 11 of the object 10 by using the chucking slot 12.

A punch hole 24 is formed in the main body 20. The punch hole 24 penetrates through the main body 20 and the fixture block 21 in turn. A bolt hole 42 is formed in the fastening piece 40. The manipulation piece 30 is a bolt. The manipulation piece 30 comprises a boss 31 penetrating through the punch hole 24. The boss 31 is divided into a first section 311 corresponding to the punch hole 24 and a second section 312 locked in the bolt hole 42. The friction of the first section 311 of the boss 31 against main body 20 is smaller than the friction of the second section 312 of the boss 31 against the fastening piece 40. In the preferred embodiment of the present invention, the second section 312 of the boss 31 is coated with a layer of expanding agent 32, so as to increase the friction between the boss 31 and the fastening piece 40.

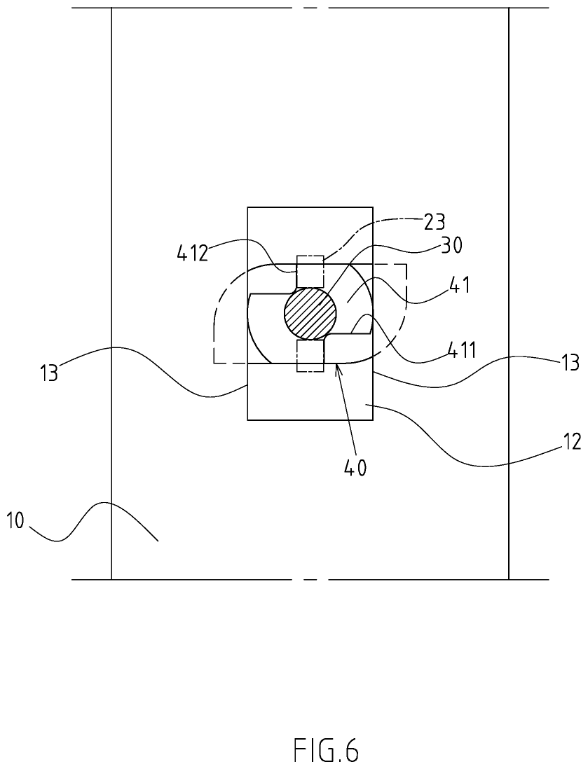

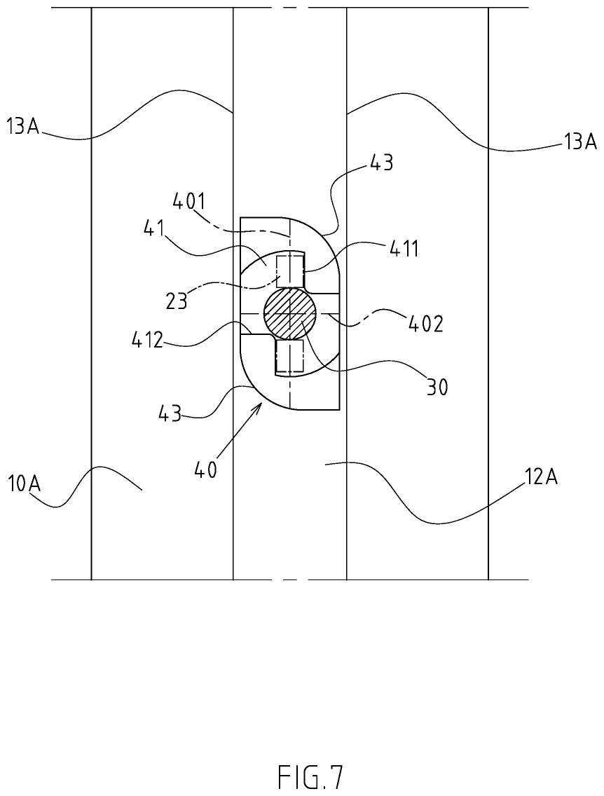

Based on said structural composition design, the actuation of the present invention is described below. As shown in FIGS. 1 and 3-6, the object 10 is a polygonal tube in this preferred embodiment. To fix the main body 20 to the object 10, the first stop face 411 props the stopper 23, and the orthographic projection of the fastening piece 40 is covered by the chucking slot 12, and then the fastening piece 40 can be placed in the holding space 11 of the object 10 by using the chucking slot 12. The two shoulders 22 cling to the outer walls of the two alar parts 13, and the fixture block 21 is chucked in the chucking slot 12, so that the main body 20 cannot rotate against the object 10. The manipulation piece 30 is turned according to the tightening direction of the boss 31. At this point, as the friction of the first section 311 of the boss 31 against main body 20 is smaller than the friction of the second section 312 of the boss 31 against the fastening piece 40, the fastening piece 40 is driven together to rotate against the main body 10. As the object 10 is a polygonal tube in this preferred embodiment, the distance from the spin axis of the fastening piece 40 to a corresponding sidewall of the holding space 11 is larger than the maximum turning radius of the fastening piece 40, the wall surface of the holding space 11 cannot provide the fastening piece 40 with any stopping effect. Finally, the stopper 23 props the second stop face 412, so that the fastening piece 40 cannot rotate against the main body 20 anymore. When the user continues turning the manipulation piece 30, the locking effect of the boss 31 and the bolt hole 42 drives the fastening piece 40 which stops spinning to move towards the two shoulders 22, till the fastening piece 40 tightly clamps the two alar parts 13 of the object 10 with the two shoulders 22, the assembly operation of the present invention is completed. To remove the present invention from the object 10, the manipulation piece 30 is turned reversely, at the moment when the fastening piece 40 does not clamp the two alar parts 13 anymore, according to said friction difference, the manipulation piece 30 drives the fastening piece 40 to rotate reversely against the main body 20. When the stopper 23 props the first stop face 411 again, and the orthographic projection of the fastening piece 40 is covered by the chucking slot 12, the fastening piece 40 can be disengaged from the holding space 11 of the object 10 by using the chucking slot 12, so as to complete the disassembling operation of the present invention. The fastening piece 40 rotates reversely against the main body 20 at the moment when it does not clamp the two alar parts 13 anymore, quick disassembly can be implemented. For the next assembly of the present invention, the fastening piece 40 can clamp the alar parts 13 quickly with the two shoulders 22 in a short period of time, so as to implement quick clamping positioning.

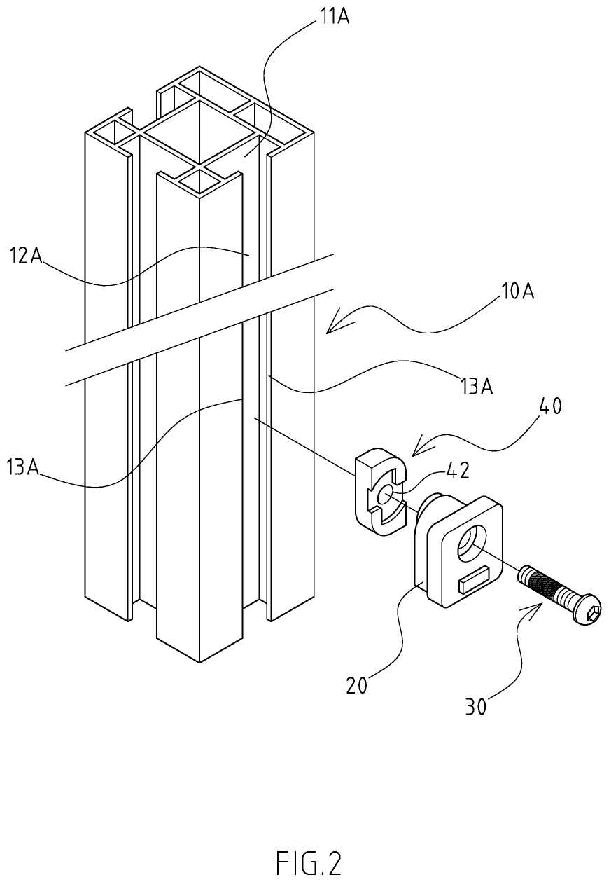

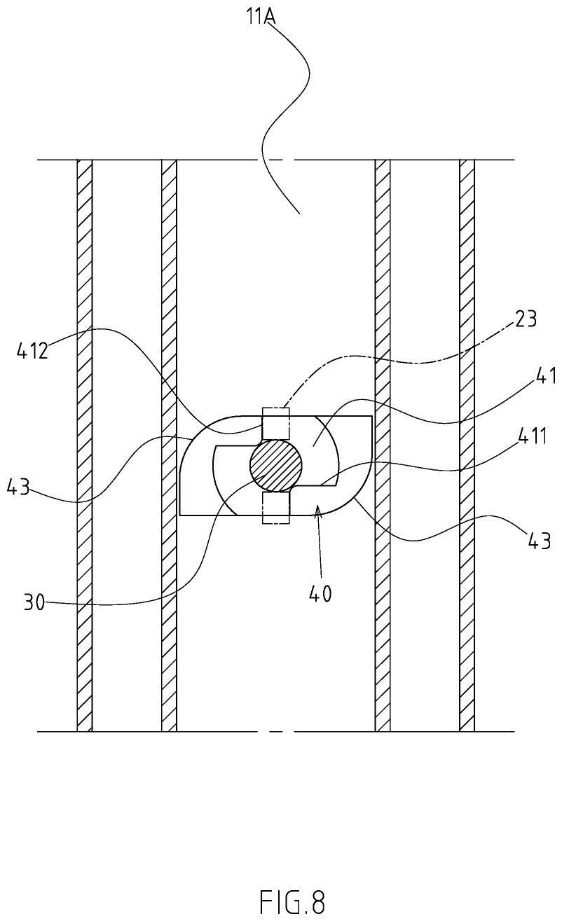

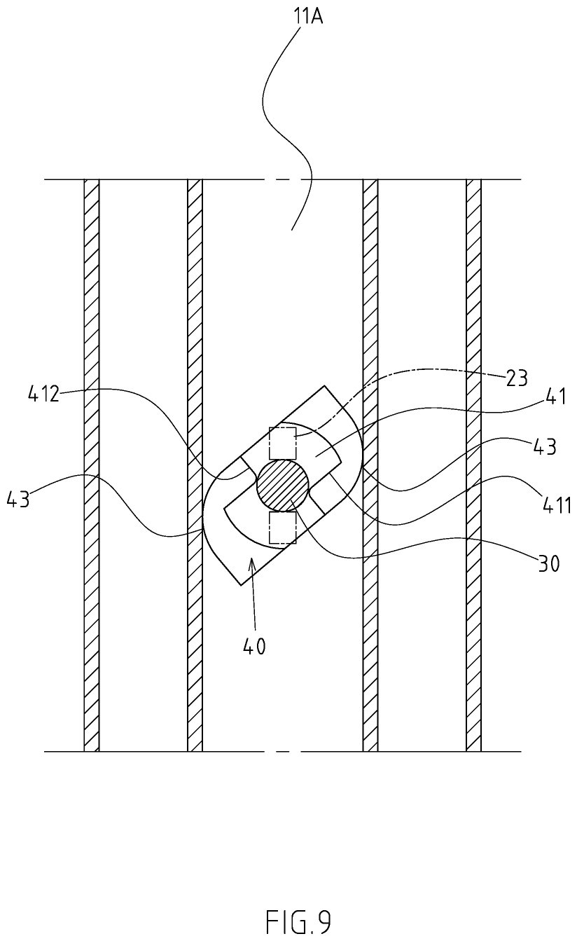

As shown in FIG. 2, in the second implementation pattern of the present invention, the object 10A is a polygonal column, and the holding space 11A and chucking slot 12A are extended longitudinally and connected to form a T-slot structure. In this implementation pattern, the structure of said object 10A is slightly different from said implementation pattern, but the structures of main body 20, manipulation piece 30 and fastening piece 40 are the same as said embodiment. The range of said specific rotation angle is determined according to the width of the holding space 11A, and the best interval is 45˜135°. As shown in FIG. 8, when the width of the holding space 11A is larger than the maximum turning radius of the fastening piece 40, and the two alar parts 13A of the object 10A are fastened, the stopper 23 props the second stop face 412 of the arc chute 41. In this preferred embodiment, the fastening piece 40 has a first side and a second side. A corresponding end of the first side and the second side is provided with an avoidance part 43 respectively. When the width of the holding space 11A is larger than the maximum turning radius of the fastening piece 40, the two avoidance parts 43 avoid the sidewall of the holding space 11A interfering in the rotating fastening piece 40. As shown in FIG. 9, when the width of the holding space 11A is smaller than the maximum turning radius of the fastening piece 40, the two avoidance parts 43 optionally prop the corresponding sidewall of the holding space 11A.

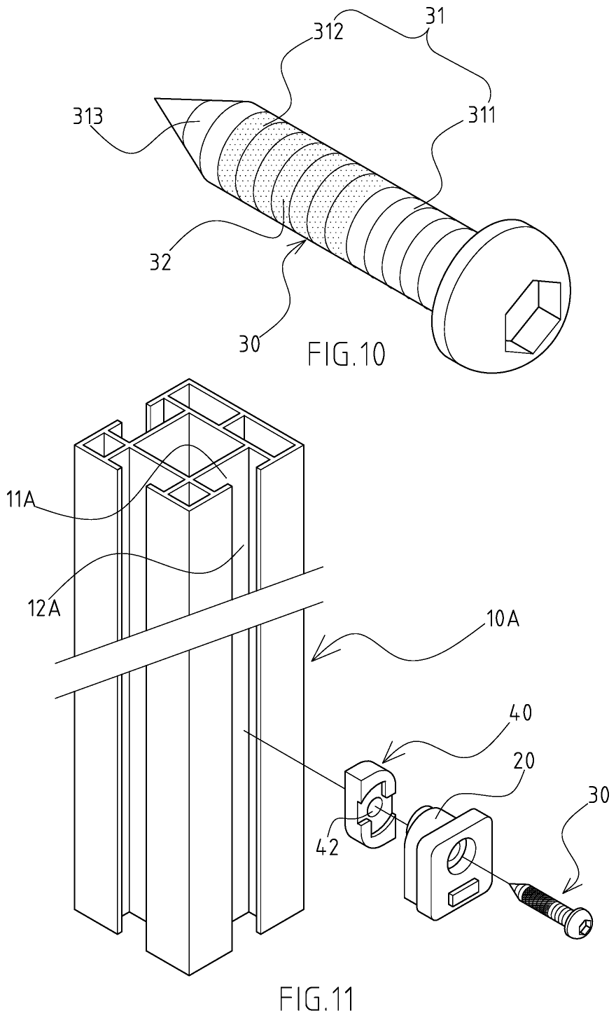

As shown in FIGS. 10 and 11, the end of the second section 312 of the boss 31 through the bolt hole 42 is axially provided with a self-tapping thread section 313, the self-tapping thread section 313 drills into the bottom surface of the holding space 11A, so as to enhance the bonding strength between the main body 20 and the object 10A.

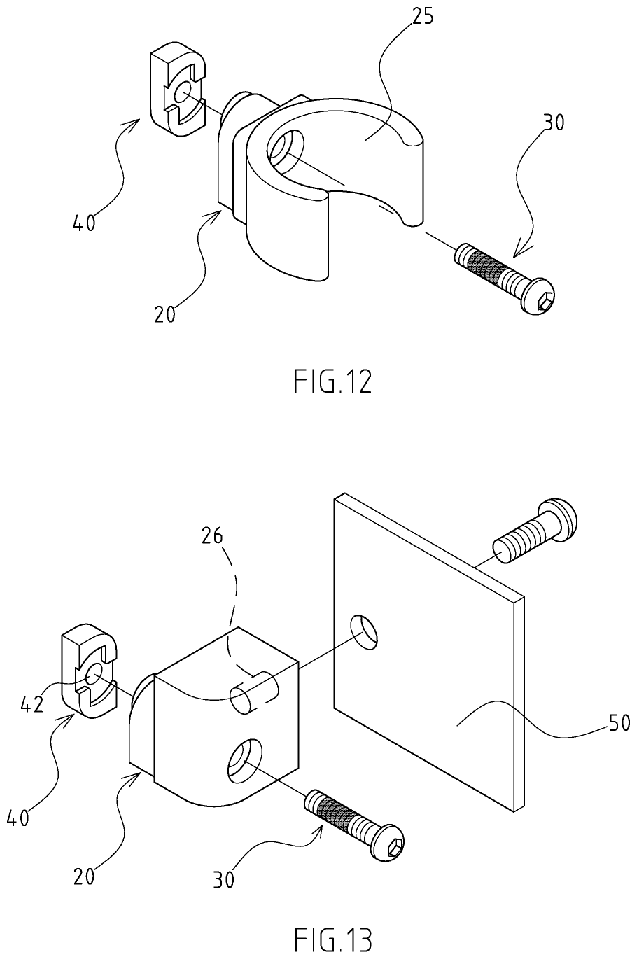

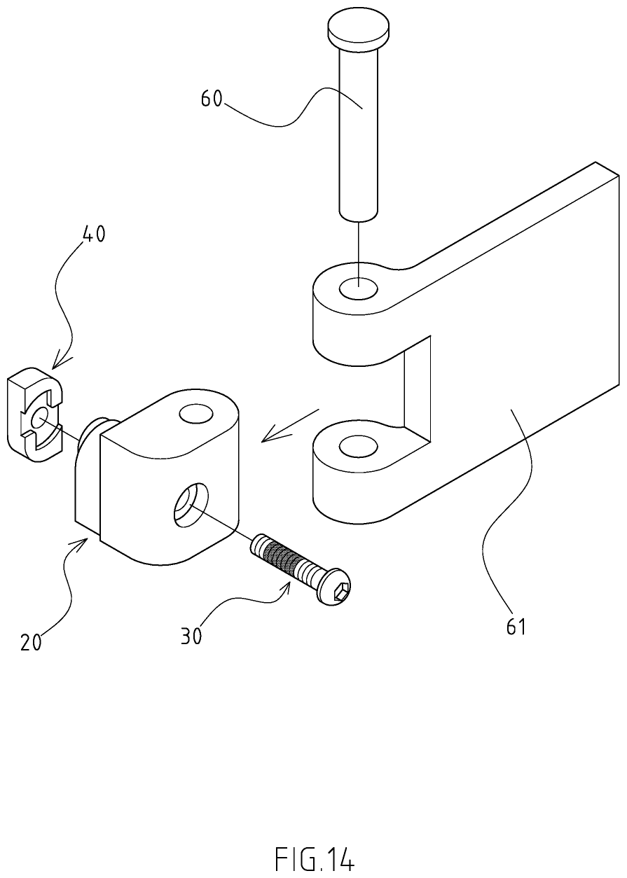

As shown in FIG. 12, the main body 20 is provided with a C-shaped buckle 25 to position a tubular object. As shown in FIG. 13, a mounting hole 26 is formed laterally in the main body 20 for a bolt to lock a plate structure 50. As shown in FIG. 14, the main body 20 is pivoted with a butterfly plate 61 by a pivot 60, so as to form a hinge structure.

We claim:

1. A quick clamping positioning device is fixed to an object with a holding space, a chucking slot connected to the holding space is formed in the surface of the object, and both sides of the chucking slot are provided with an alar part respectively, wherein the chucking slot is a strip structure; the quick clamping positioning device comprises:
a main body;
a fixture block, the fixture block protrudes from the main body and is to be chucked in the chucking slot;
two shoulders, the two shoulders are arranged on the main body and on both sides of the fixture block;
a manipulation piece, the manipulation piece rotatably penetrates through the main body and the fixture block in turn; and
a fastening piece, the fastening piece is fixed to the manipulation piece, and arranged corresponding to the top surface of the fixture block; the fastening piece is an approximately long structure with a major axis and a minor axis, wherein the length of major axis of the fastening piece is smaller than the length of the chucking slot, and the length of minor axis of the fastening piece is smaller than the width of the chucking slot; the fastening piece is to penetrate through the chucking slot and held in the holding space; the fastening piece is driven by the manipulation piece to optionally rotate at a specific rotation angle against the main body, and to optionally clamp the two alar parts of the object with the two shoulders.

2. The quick clamping positioning device defined in claim 1, wherein an arc chute is formed in one face of the fastening piece corresponding to the fixture block, one end of the arc chute corresponding to the major axis is defined as a first stop face, and one end of the arc chute corresponding to the minor axis is defined as a second stop face; a stopper held in the arc chute protrudes from the top surface of the fixture block; when the stopper props the first stop face, and the orthographic projection of the fastening piece is covered by the chucking slot, the fastening piece can be disengaged from/placed in the holding space of the object by using the chucking slot.

3. The quick clamping positioning device defined in claim 2, wherein the specific rotation angle is 45-135°, when the distance from the spin axis of the fastening piece to a corresponding sidewall of the holding space is larger than the maximum turning radius of the fastening piece, the stopper optionally props the second stop face.

4. The quick clamping positioning device defined in claim 3, wherein the fastening piece has a first side and a second side; a corresponding end of the first side and the second side is provided with an avoidance part respectively; when the width of the holding space is larger than the maximum turning radius of the fastening piece, the two avoidance parts avoid the sidewall of the holding space interfering in the rotating fastening piece; when the width of the holding space is smaller than the maximum turning radius of the fastening piece, the two avoidance parts optionally prop the corresponding sidewall of the holding space.

5. The quick clamping positioning device defined in claim 1, wherein a punch hole is formed in the main body, the punch hole penetrates through the main body and the fixture block in turn; a bolt hole is formed in the fastening piece; the manipulation piece is a bolt, the manipulation piece has a boss penetrating through the punch hole; the boss is divided into a first section corresponding to the punch hole and a second section fixed into the bolt hole; the friction of the first section of the boss against the main body is smaller than the friction of the second section of the boss against the fastening piece.

6. The quick clamping positioning device defined in claim 2, wherein a punch hole is formed in the main body, the punch hole penetrates through the main body and the fixture block in turn; a bolt hole is formed in the fastening piece; the manipulation piece is a bolt, the manipulation piece has a boss penetrating through the punch hole; the boss is divided into a first section corresponding to the punch hole and a second section fixed into the bolt hole; the friction of the first section of the boss against the main body is smaller than the friction of the second section of the boss against the fastening piece.

7. The quick clamping positioning device defined in claim 3, wherein a punch hole is formed in the main body, the punch hole penetrates through the main body and the fixture block in turn; a bolt hole is formed in the fastening piece; the manipulation piece is a bolt, the manipulation piece has a boss penetrating through the punch hole; the boss is divided into a first section corresponding to the punch hole and a second section fixed into the bolt hole; the friction of the first section of the boss against the main body is smaller than the friction of the second section of the boss against the fastening piece.

8. The quick clamping positioning device defined in claim 4, wherein a punch hole is formed in the main body, the punch hole penetrates through the main body and the fixture block in turn; a bolt hole is formed in the fastening piece; the manipulation piece is a bolt, the manipulation piece has a boss penetrating through the punch hole; the boss is divided into a first section corresponding to the punch hole and a second section fixed into the bolt hole; the friction of the first section of the boss against the main body is smaller than the friction of the second section of the boss against the fastening piece.

9. The quick clamping positioning device defined in claim 5, wherein the end of the second section of the boss through the bolt hole is axially provided with a self-tapping thread section, the self-tapping thread section drills into the bottom surface of the holding space, so as to enhance the bonding strength between the main body and the object.

10. The quick clamping positioning device defined in claim 6, wherein the end of the second section of the boss through the bolt hole is axially provided with a self-tapping thread section, the self-tapping thread section drills into the bottom surface of the holding space, so as to enhance the bonding strength between the main body and the object.

11. The quick clamping positioning device defined in claim 7, wherein the end of the second section of the boss through the bolt hole is axially provided with a self-tapping thread section, the self-tapping thread section drills into the bottom surface of the holding space, so as to enhance the bonding strength between the main body and the object.

12. The quick clamping positioning device defined in claim 8, wherein the end of the second section of the boss through the bolt hole is axially provided with a self-tapping thread section, the self-tapping thread section drills into the bottom surface of the holding space, so as to enhance the bonding strength between the main body and the object.

13. The quick clamping positioning device defined in claim 1, wherein the main body is provided with a C-shaped buckle, so as to position a tubular object.

14. The quick clamping positioning device defined in claim 2, wherein the main body is provided with a C-shaped buckle, so as to position a tubular object.

15. The quick clamping positioning device defined in claim 1, wherein a mounting hole is formed laterally in the main body for a bolt to lock a plate structure.

16. The quick clamping positioning device defined in claim 2, wherein a mounting hole is formed laterally in the main body for a bolt to lock a plate structure.

17. The quick clamping positioning device defined in claim 1, wherein the main body is pivoted with a butterfly plate by a pivot, so as to form a hinge structure.

18. The quick clamping positioning device defined in claim 2, wherein the main body is pivoted with a butterfly plate by a pivot, so as to form a hinge structure.
